(19) United States
(12) Patent Application Publication
(10) Pub. No.: US 2025/0330686 A1
(43) Pub. Date: Oct. 23, 2025

(54) SYSTEMS AND METHODS FOR EMBEDDING EXTERNAL CONTENT

(71) Applicant: ServiceNow, Inc., Santa Clara, CA (US)

(72) Inventors: Rohan Hemachandra Rasane, San Jose, CA (US); Rafael Lagares Vale, San Diego, CA (US); Corey Daniel Leamon, Escondido, CA (US); Pooja Vijay Patil, Carlsbad, CA (US); Justin Michael denBroeder, San Diego, CA (US); Benjamin Michael Holland-Arlen, Encinitas, CA (US); Alonzo Castanon, El Cajon, CA (US)

(21) Appl. No.: 18/642,231

(22) Filed: Apr. 22, 2024

(51) Int. Cl. H04N 21/81; G06F 3/04842

(52) U.S. Cl. CPC H04N 21/8153; G06F 3/04842; H04N 21/8173

(57) ABSTRACT

A method including generating a content design graphical user interface (GUI) and an end user GUI. The content design GUI receives a first input selecting a content source of one or more available content sources, each having one or more content parameters and receiving a second input selecting one or more content parameters from the one or more content parameters of the selected content source. The content design GUI also receives a third input selecting an access parameter defining one or more user profiles authorized to view the selected content source. The end user GUI renders a content item associated with the selected content source, the one or more selected content parameters, and the selected access parameter via a display of one or more client devices.

### TECHNICAL FIELD

The present disclosure relates generally to a content publishing application. Specifically, the present disclosure relates to embedding externally hosted content within a graphical user interface (GUI) of a platform.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations and such resources may be used to perform a variety computing functions (e.g., storing and/or processing large quantities of computing data).

For enterprise and other organization users, cloud computing provides flexibility in resources utilized and/or provided by the enterprise. For example, incorporation of cloud-accessible content, including videos, learning materials, and/or specialized dashboards, may create user engagement. However, embedding content hosted externally (e.g., hosted outside of the platform and/or hosted by a different enterprise) in such resources (e.g., customized applications and/or websites) may result in issues, such as the content not being displayed properly, the content not matching the aesthetics of the application or website, the content not being able to play within the application or website, and so forth. Accordingly, improved techniques for embedding third-party content including videos, webinars, and the like as part of the cloud computing services are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A content publishing application is disclosed herein that enables integration and compatibility of externally hosted content within a platform of an enterprise. The content publishing application may offer streamlined access management of externally hosted content. In this manner, the content publishing application may provide only a portion of employee profiles access to externally hosted content. Further, the content publishing application may allow content (e.g., third-party content) to be configured for integration onto a platform of the enterprise.

In certain aspects, the present disclosure is generally directed to a method including generating a content design graphical user interface (GUI) and an end user GUI. The content design GUI receives a first input selecting a content source of one or more available content sources, each having one or more content parameters and receives a second input selecting one or more content parameters from the one or more content parameters of the selected content source. The content design GUI also receives a third input selecting an access parameter defining one or more user profiles authorized to view the selected content source. The end user GUI renders a content item associated with the selected content source, the one or more selected content parameters, and the selected access parameter via a display of one or more client devices.

The present disclosure is directed to a system including processing circuitry and memory, accessible by the processing circuitry, the memory storing instructions that, when executed by the processing circuitry, cause the processing circuitry to perform operations. The operations include generating a content design graphical user interface (GUI). The content design GUI is configured to receive a first input selecting a content source of one or more available content sources, each having one or more content parameters, to receive a second input selecting one or more content parameters from the one or more content parameters of the selected content source, and to receive a third input selecting an access parameter defining one or more user profiles authorized to view the selected content source. The operations also include generating an end user GUI to render a content item associated with the selected content source, the one or more selected content parameters, and the selected access parameter via a display of one or more client devices and embed the content item within a video player of a platform.

The present disclosure is directed to a non-transitory computer-readable storage medium including processor-executable routines that, when executed by a processor, cause the processor to perform operations. The operations include generating a content design graphical user interface (GUI) configured to receive a first input selecting a content source of one or more available content sources, each having one or more content parameters, to receive a second input selecting one or more content parameters from the one or more content parameters of the selected content source, and to receive a third input selecting an access parameter, wherein the access parameter defines one or more user profiles authorized to view the selected content source. The operations also include generating an end user GUI to render a content item associated with the selected content source, the one or more selected content parameters, and the selected access parameter via a display of one or more client devices.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRA WINGS

Various aspects of this disclosure may be better understood upon reading the following detailed description and upon reference to the drawings in which:

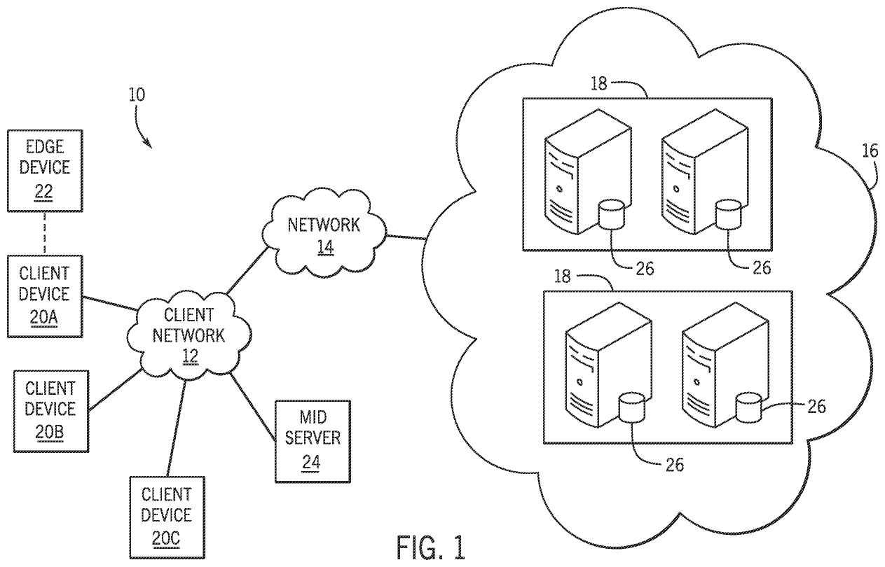

FIG. 1 is a block diagram of an embodiment of a multi-instance cloud architecture in which embodiments of the present techniques may operate;

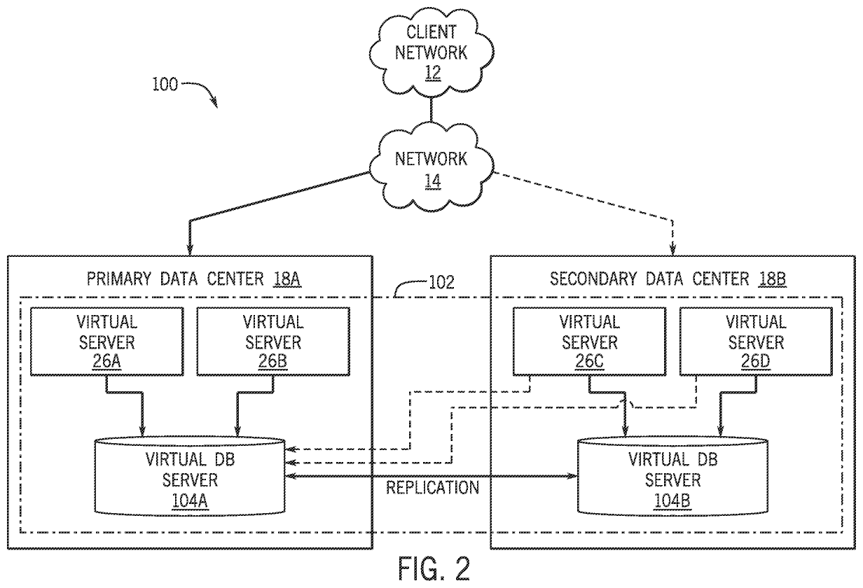

FIG. 2 is a schematic diagram of an embodiment of a multi-instance cloud architecture in which embodiments of the present techniques may operate;

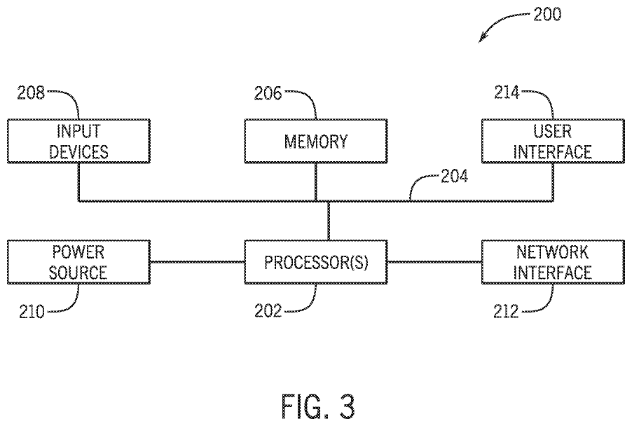

FIG. 3 is a block diagram of a computing device utilized in a computing system that may be present in FIG. 1 or 2, in accordance with aspects of the present techniques;

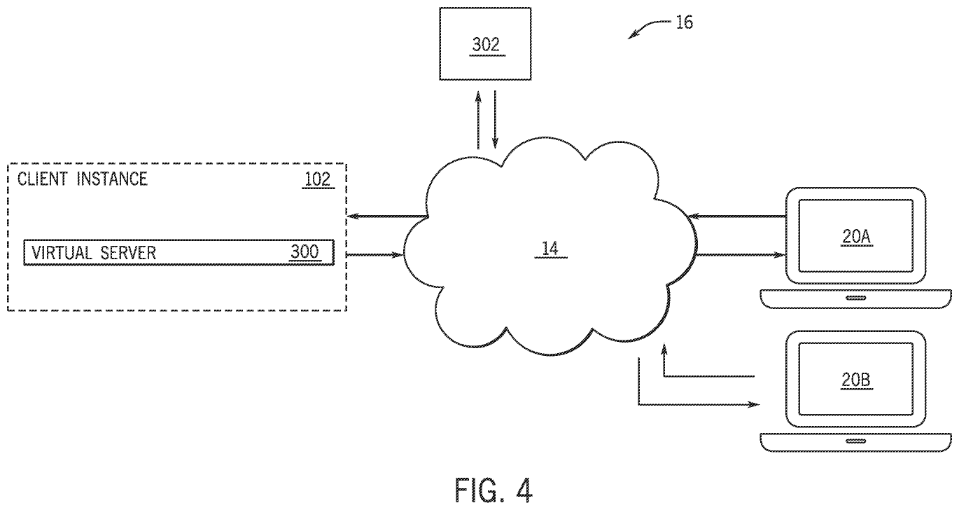

FIG. 4 is a block diagram illustrating an embodiment in which a virtual server supports and enables the client instance, in accordance with aspects of the present techniques;

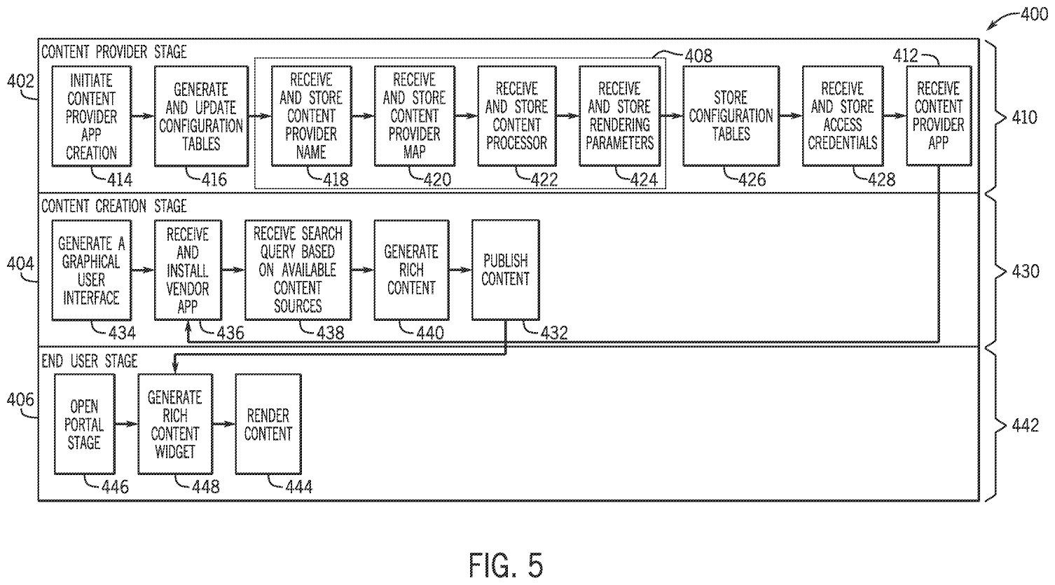

FIG. 5 is a schematic illustrating a framework of a content publishing application to be utilized within an enterprise, in accordance with aspects of the present techniques;

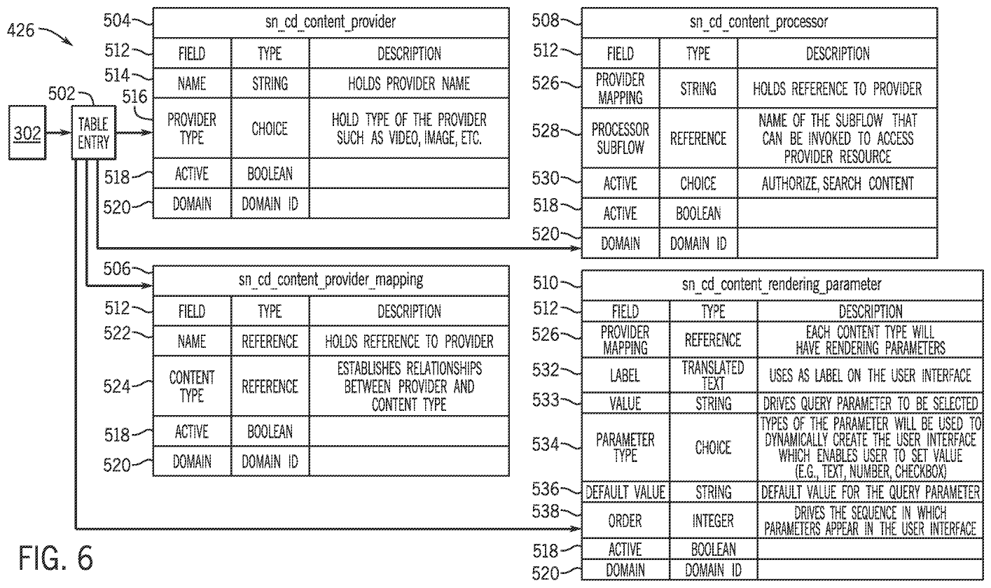

FIG. 6 is a schematic embodiment of one or more configuration tables of a content provider stage in reference to FIG. 5, in accordance with aspects of the present techniques;

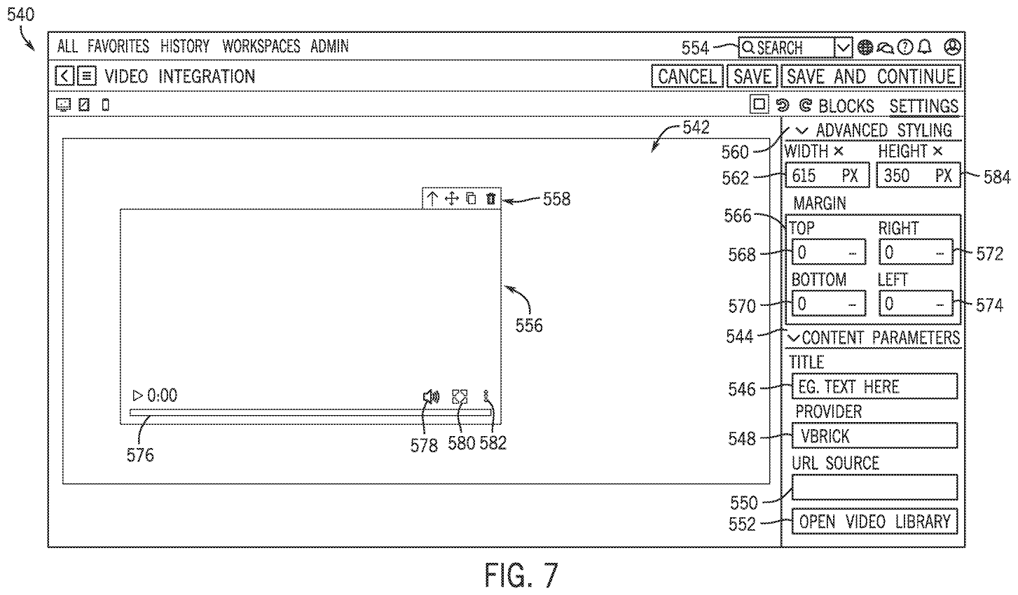

FIG. 7 is a schematic embodiment of a graphical user interface (GUI) generated within a content creation stage of a content publishing application, in accordance with aspects of the present techniques;

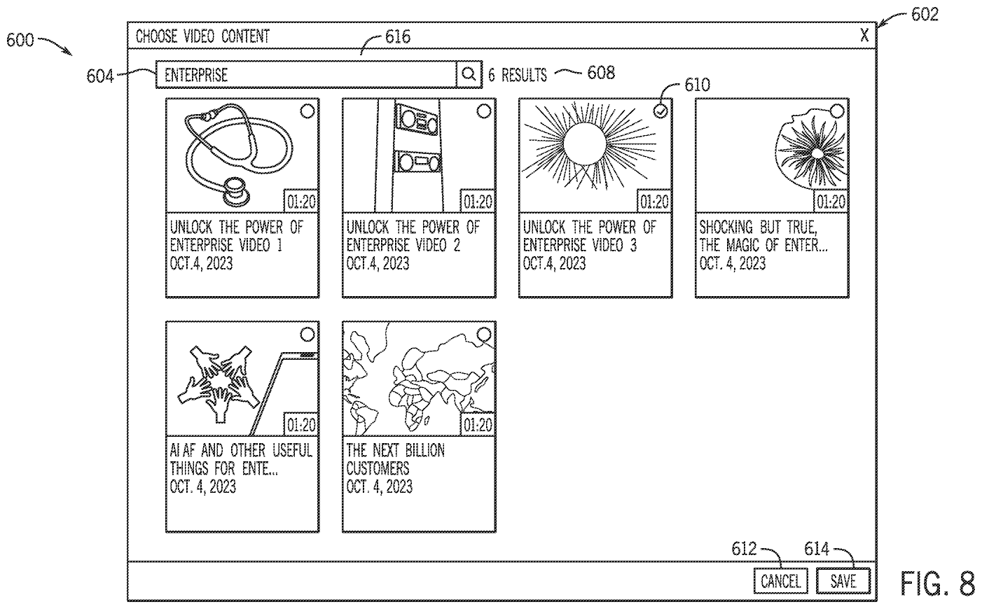

FIG. 8 is a schematic embodiment of a screen displaying a search window of the content publishing application, in accordance with aspects of the present techniques;

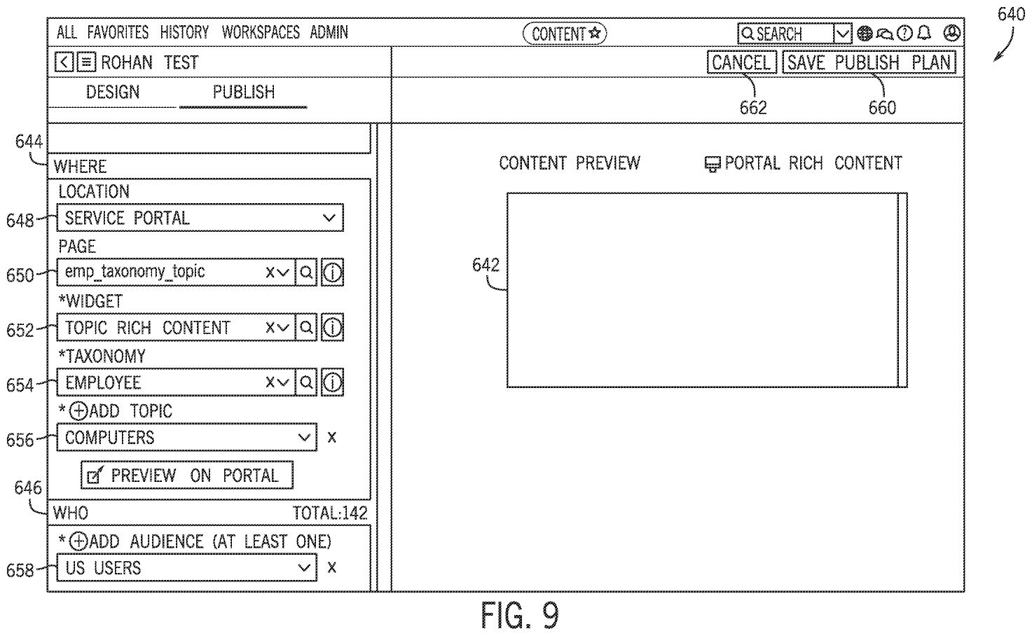

FIG. 9 is a schematic embodiment of the GUI generated within the content creation stage of a publication screen of the content publishing application, in accordance with aspects of the present techniques;

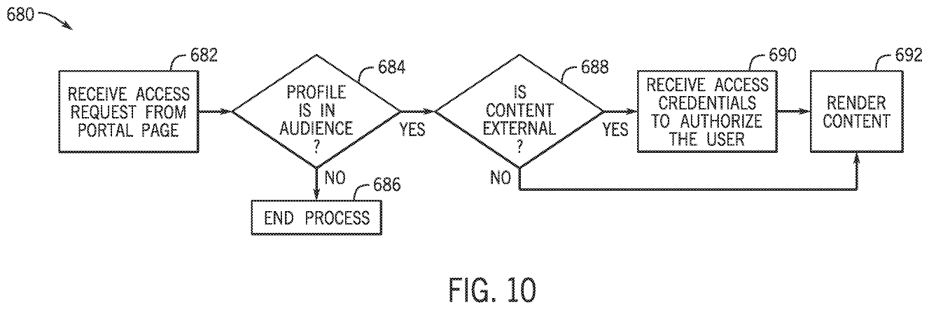

FIG. 10 is a process of generating a content widget of an access workflow of the content publication system, in accordance with aspects of the present techniques; and

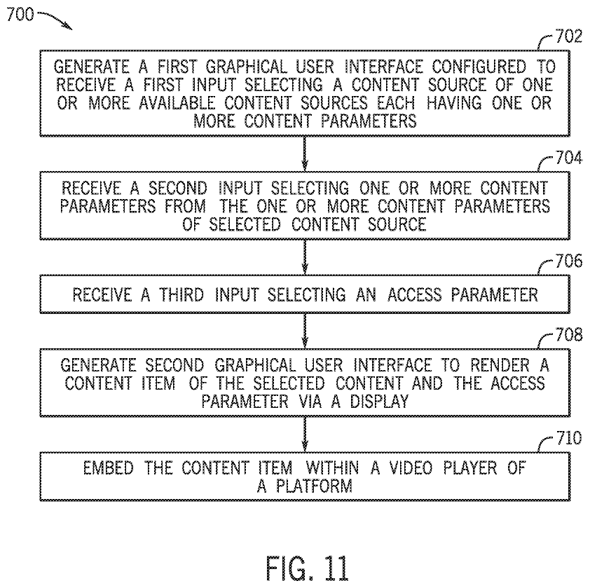

FIG. 11 is a process for generating a content design GUI and an end user GUI of the content publication system, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In modern communication networks, examples of cloud computing services include software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client devices as needed. For example, client devices are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for developing, modifying, and/or customizing applications and/or automating enterprise operations without maintaining network infrastructure and/or allocating computing resources normally associated with these functions.

These cloud computing services may allow for customization of applications and/or websites accessed or provided by an enterprise, such as to foster user (e.g., customer or employee) engagement. For example, incorporation of various content including videos, learning materials, and/or specialized dashboards may create user engagement. As such, the enterprise may seek to integrate third-party content (e.g., content hosted externally to the enterprise) including videos, webinars, and the like as part of the cloud computing services. Currently, there is no streamlined process for incorporating externally hosted content into cloud computing services. As such, embedding content hosted externally (e.g., hosted outside of the platform and/or hosted by a different enterprise) in such resources (e.g., customized applications and/or websites of cloud computing services) may result in issues, such as the content not being displayed properly, the content not matching the aesthetics of the application or website, the content not being able to play within the application or website, and so forth. For example, externally hosted content may be access controlled and may call for additional authentication and/or authorization via client devices when attempting to view externally hosted content. Further, externally hosted videos and webinars may include various video rendering parameters that may provide challenges as the enterprise seeks to ensure compliance with company policies. Accordingly, it can be difficult to embed externally hosted content in websites and applications of the enterprise. As such, there is a need for streamlined integration of externally hosted content within the cloud computing services.

Accordingly, the presently disclosed techniques may be used to improve techniques for embedding externally hosted content including videos, webinars, and the like as part of cloud computing services. A content publishing application is described herein that enables integration and compatibility of externally hosted content within a platform (e.g., a web portal, a cloud-based developmental platform) of an enterprise. In this manner, seamless access to content may be offered, providing content for display via client devices, while authentication and/or authorization of viewership may be controlled in a background of the platform. The content publishing application may also ensure compliance with a content management strategy of the enterprise by offering streamlined access management of externally hosted content. In this manner, the content publishing application may provide only a portion of employee profiles (e.g., end user profiles) access to externally hosted content. Further, the content publishing application may allow content (e.g., third-party content) to be configured for integration onto the platform of the enterprise. In particular, present embodiments include mapping of application programming interfaces (APIs) for dynamic incorporation into the platform. As such, mapping of APIs may allow for customizable content rendering parameters, searchability of content, and authorization of viewer credentials. Integration of externally hosted content on the platform of the enterprise allows streamlined access of content as part of cloud computing services. Previously, embedding of externally hosted content was cumbersome, as integration with platforms of enterprises may include credential authorization, display issues, playback failures, and the like.

Additionally, present embodiments include creation of a graphical user interface (GUI) designed to guide configuration of content (e.g., content design) through a series of inputs to publish externally hosted content within the platform of the enterprise. In this manner, content rendering parameters may be selected, content access may be managed, and content may be published to ensure externally hosted content aligns with the content management strategy of the enterprise. Externally hosted content as used herein refers to content (e.g., videos, audio clips, modules, and the like) hosted by a server independent of the enterprise and/or external to client instances of the enterprise. Further, present embodiments include a GUI (e.g., end user GUI) to be displayed by client devices (e.g., end user devices) that provides access to published content within the cloud-based developmental platform of the enterprise. In this manner, the content publishing application provides streamlined incorporation of content that may include videos, learning materials, and/or specialized dashboards fostering dynamic engagement with the content.

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to one or more client devices 20 that may include a content creator device 20A (e.g., content administrator device), and an end user device 20B (e.g., employee device) via the network 14 to provide a user interface to network applications executing within the client instance 102 (e.g., via a web browser of the content creator device 20A and/or the end user device 20B). Client instance 102 is supported by virtual servers 26 similar to those explained with respect to FIG. 2, and is illustrated here to show support for the disclosed functionality described herein within the client instance 102. A content provider server 302 may be connected to the network 14. In this manner, the content provider server 302 may provide externally hosted content to the cloud-based platform 16 of the enterprise. In some embodiments, the content provider server 302 may generate a content provider application that may include configuration tables. As such, the cloud-based platform 16 may retrieve data associated with externally hosted content of the content provider server 302. Cloud provider infrastructures are generally configured to support a plurality of end-user devices, such as client devices 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user profile associated with a given authenticated user may also determine the manner and access provided to the user via the interface with client instance 102, such as using an application that is executed within a web browser provided on a given client device 20.

With this in mind, FIG. 5 is a framework 400 of a content publishing application to be utilized within an enterprise. The content publishing application promotes integration and compatibility of externally hosted content (e.g., content hosted on another platform external to the enterprise) within a platform (e.g., a cloud-based developmental platform) of the enterprise. In this manner, the content publishing application retrieves content provider related parameters (e.g., configuration tables, APIs), generates tailored content (e.g., end user specific) via creator development, and publishes tailored content for users of the enterprise. Further, one or more stages may be included in the framework 400 of the content publishing application. It should be noted, the framework 400 of FIG. 5 is one non-limiting example of the content publishing application and that the illustrated stages are provided as examples and more, fewer, or different stages may be included in the framework 400 of the content publishing application. Further, one or more stages of the framework 400 may be executed by the content provider server 302, the content creator device 20A, the end user device 20B, or any other suitable device(s) or controller(s).

As shown, the stages encompassed in the content publishing application may include a content provider stage 402, a content creation stage 404, and an end user stage 406. The content provider stage 402 includes a content provider workflow 410 that may be followed to retrieve a content provider application at block 412 and one or more configuration tables 408 associated with one or more content sources of the content provider. The configuration tables 408 may include one or more parameters (e.g., APIs, API mapping, processors, rendering parameters, and the like) associated with the content sources made available (e.g., one or more available content sources, content sources retrieved from the content provider) by the content provider. The content provider workflow 410 may initiate creation of the content provider application at block 414. The content provider application may be used by the content provider server 302 to enable the available content sources provided by the content provider to be hosted on the platform of the enterprise. In this manner, the content creator device 20A may incorporate the available content sources of the content provider into the platform via the content provider application. As such, the content provider application may be generated based on a request from a content creator and/or the content provider. In some embodiments, it may be advantageous for the content provider to generate the content provider application to provide ease of access to the available content sources in a centralized format.

At block 416 of the content provider workflow 410, the content publication application may generate and/or update the configuration tables 408. For example, the content publication application may provide one or more subflows (e.g., error routine, access controls, business rules, user interface actions, client scripts, and the like), one or more connection aliases (e.g., endpoints to access an API, connection URL, HTTP(s) connection, and the like), one or more additional parameters, or a combination thereof to the configuration tables 408. With this in mind, at block 418 the content publication application may receive and store a content provider name to a first configuration table. In this manner, the first configuration table may provide the content provider name (e.g., third-party identifier). In some embodiments, the first configuration table may be searchable via a query function. In this way, the content provider name may be selected from a list of content providers prior to access of one or more additional configuration tables. Further, at block 420 of the content provider workflow 410 the content publication application may receive and store a content provider map (e.g., API maps, access script, connection URL, content file path) to a second configuration table. In this way, the second configuration table may include the content provider map corresponding to the content provider name selected at block 418. In some embodiments, the content provider map may be used to retrieve one or more content sources hosted (e.g., stored) by the content provider server 302 at a location external to the platform of the enterprise.

In the illustrated embodiment, at block 422 of the content provider workflow 410 the content publication application may receive and store one or more content processors associated with the available content sources to a third configuration table. The third configuration table may provide access to the content processors of the content provider to provide access to the available content sources of the content provider. Further still, at block 424 of the content provider workflow 410, the content publication application may receive and store one or more rendering parameters in a fourth configuration table. The fourth configuration table may be accessed by the content publication application to determine one or more content parameters (e.g., the rendering parameters) associated with the available content. For example, in some embodiments, the available content may include a webinar. In this way, the content parameters (e.g., playback parameters) associated with the webinar may include a playback volume, an orientation, a resolution, a language preference, an auto play feature, a full screen parameter, a play in line parameter, a load policy, and the like.

With this in mind, it should be noted that the configuration tables 408 may provide any suitable content parameters (e.g., rendering parameters, playback parameters, display parameters, and the like) relating to the available content sources of the content provider. As such, at block 426 of the content provider workflow 410 the content publication application may store one or more of the configuration tables 408 in the content provider application. Further, at block 428 of the content provider workflow 410 the content provider stage 402 receives and stores one or more access credentials associated with the available content sources of the content provider. The access credentials may be based on an authorization status (e.g., access parameter) of one or more end user profiles that may view the available content sources. In this manner, the content provider may be able to control access to the available content sources through integration of access credentials provided by the enterprise. In some embodiments, the access credentials may include a token, a username, a password, and the like. In some embodiments, storage of the access credentials within the content provider application may allow for streamlined access to the available content by a particular end user profile of the enterprise. For example, the access credentials stored within the content provider application may allow access to the available content sources on the platform of the enterprise using a single sign-in configuration. That is, access-controlled content hosted by the content provider may be viewed on the platform by the particular end user profile without additional authorization requirements.

In certain embodiments, at block 412, the content provider workflow 410 of the content publication application may output the content provider application for use in the content creation stage 404, the end user stage 406, and/or additional stages or workflows of the content publishing application. The content provider application may include the configuration tables 408 corresponding to the available content sources of the content provider. Additionally and/or alternatively, access control of the available content sources may be managed via the access credentials. In this way, the content provider server 302 may update, monitor, and/or vary the content sources made available to the content creator device 20A and the end user device 20B of the content publishing application.

In some embodiments, the configuration tables 408 may be retrieved and/or updated by retrieving the content provider application. For example, FIG. 6 is a schematic embodiment of the configuration tables 408 of the content provider stage 402 in reference to FIG. 5. As shown, the content publication application may retrieve and/or update one or more table entries 502 to generate various configuration tables from the content provider server 302. As shown, the configuration tables 408 may include an externally hosted content table 504 (e.g., configuration table), a provider mapping table 506, a content processor table 508, and/or a content parameter table 510 (e.g., configuration table). In this manner, the externally hosted content table 504, the provider mapping table 506, the content processor table 508, and/or the content parameter table 510 may be accessed during the content creation stage 404 to provide information relating to the available content sources of the content provider.

In the illustrated embodiment, the externally hosted content table 504 may include one or more content source inputs 512 that may be stored within the content provider application. The content source inputs 512 may include an input field, an input type, and/or an input description for each entry to the configuration tables 408. For example, the input field of the content source inputs 512 may include a name 514, a provider type 516, a status 518, a domain name 520, and/or additional inputs. The name 514 may include a provider identification, an URL, and the like. In some embodiments, the name 514 may be stored in the externally hosted content table 504 as a string (e.g., text string). The provider type 516 (e.g., content type) may include a video, a webinar, a module, an image, and other suitable content types that may be used by the content publishing application. The status 518 may include an active status or an inactive status based on an availability of the content source inputs. The status 518 may be stored as a Boolean input or other suitable conditional input types. The domain name 520 may include a domain ID. In this manner, the externally hosted content table 504 may provide the domain name 520 used to input the content source inputs 512.

As shown, the provider mapping table 506 may include the one or more content source inputs 512. The content source inputs 512 may include a provider reference 522, a content type 524, the status 518, and the domain name 520. The provider reference 522 may include reference to the provider of the available content sources. The content type 524 may include one or more types of content that may be made available by the content provider server 302. For example, in some embodiments, the content type 524 is a live webinar. As such, the status 518 (e.g., access status) of the webinar may include an inactive status prior to a start time of the webinar. Further, at and/or after the start time of the webinar the status 518 of the webinar may be updated to an active status. In this way, the provider mapping table 506 may update the status 518 of the content type 524 dynamically based on one or more conditions (e.g., publication status, playback status, and the like) of the available content sources.

With this in mind, in some embodiments, the provider mapping table 506 may include one or more additional content source inputs 512. The additional content source inputs may include one or more error message subflows. The error message subflows may provide one or more steps storing information related to errors (e.g., triggered errors) in a database that may be accessed to determine a cause of errors that may occur during access, use, or storage of the content source inputs in the externally hosted content table 504 and/or errors relating to retrieval and/or availability of the available content sources of the content provider. The externally hosted content table 504 may also include a default image. The default image may be a thumbnail of a video, a placeholder image, or any other suitable image that may be included when the externally hosted content table 504 is accessed, searched, and the like. For example, the webinar may have a thumbnail image associated with the webinar that may be store in the externally hosted content table 504 for use of the content provider application.

In the illustrated embodiment, the content processor table 508 may include one or more content source inputs 512. In this manner, the content processor table 508 may include a provider mapping field 526, a processor subflow 528, an action field 530, the status 518, and the domain name 520. The provider mapping field 526 may include reference to the content provider server 302. The processor subflow 528 may include a subflow name (e.g., processor name, host name) or any suitable identifier that may provide access to the content source inputs 512 retrieved from the content provider server 302. The action field 530 may include a choice (e.g., selection) to authorize and/or approve search (e.g., query) of content provided by the content provider server 302.

In certain embodiments, the content parameter table 510 may be retrieved from the content provider server 302. In this manner, the content parameter table 510 may include information relating to one or more content parameters of the available content of the content provider. In some embodiments, the content parameter table 510 includes the content source inputs 512 that may include the provider mapping field 526, an input label 532, a content value 533, a parameter type 534, a default value 536, an order 538, the status 518, the domain name 520, or a combination thereof. It should be noted that the content parameter table 510 may include one or more additional content source inputs 512 such as the provider type 516, the content type 524, the processor subflow 528, and/or additional inputs of the externally hosted content table 504, the provider mapping table 506, and/or the content processor table 508. In addition, a video manager may include information related to the content parameters of the available content of the content provider. In this manner, the input label 532 may be a video identification, a video mode, an URL, an auto play format, a volume, an orientation, a resolution, a pixel size, and the like. With this in mind, the parameter type 534 may include a format associated with the content parameter. In this manner, the parameter type 534 may include a string, a password, a lookup, a time, an integer, a formatted string, a real-time dynamic choice, and/or additional formats.

In some embodiments, the content value 533 of the content parameter table 510 may correspond to the provider mapping field 526 and the parameter type 534 of the content parameter table 510. For example, in some embodiments, the provider mapping field 526 is a URL and the parameter type 534 is a string. As such, the content value 533 may be a URL address in a string format. In this manner, the content parameter table 510 may include various content values may be stored and/or accessed in the content provider application to direct a user to the available content.

In some embodiments, the default value 536 may be provided during query of the content parameter table 510. For example, in some instance the content value 533 may not be provided. In this way, the default value 536 may provide search terms related to the provider mapping field 526, the input label 532, or additional content source inputs 512 that may be include in the content parameter table 510. Further, the content parameter table 510 may include the order 538. The order 538 may indicate to the content provider server 302 a sequence in which the parameter type 534 may be listed on a user interface. In this manner, if one or more of the content parameters may be desirable for use in the order 538 may be provided by the configuration table. In this way, the externally hosted content table 504, the provider mapping table 506, the content processor table 508, and/or a content parameter table 510 may organize parameters of the available content sources (e.g., content provider content) in such a way that the available content sources of the content provider may be retrieved and embedded within the platform of the enterprise. In this manner, the content publishing application may access the externally hosted content table 504 during design, development, and playback of externally hosted content.

Returning to FIG. 5, the content publishing application may generate a graphical user interface (GUI) (e.g., a content design GUI) to provide a content publication workflow to publish content to the platform of the enterprise. As such, the content creation stage 404 includes a content publication workflow 430 that may provide one or more processes to publish content based on parameters stored within the content provider application of the content provider stage 402 at block 432 of the content publication workflow 430. In general, the content creation stage 404 allows the content creator device 20A to develop streamlined access management and display of externally hosted content (e.g., available content sources) within the platform of the enterprise via the content design GUI. Development and display of externally hosted content may require access to the configuration table 408 retrieved from the content provider server 302 during the content provider stage 402 of the framework 400. As such, at block 434 of the content publication workflow 430 the content publishing application generates the GUI. In some embodiments, a content creator profile (e.g., employee profile) of the enterprise may access a design canvas of the content design GUI to design, upload, link, and/or embed content for use by one or more end user profiles.

In some embodiments, during the content publication workflow 430, the content publishing application may access content hosted by the content provider (e.g., available content source) for development and customization. As such, the content provider application may be installed (e.g., retrieved from block 412 of the content provider workflow 410) at block 434 of content publication workflow 430. In some embodiments, the content provider application may include the configuration tables 408 and/or access credentials retrieved via the content provider workflow 410. In this manner, content parameters, mapping, and access status may be provided to the content creator device 20A for incorporation in the design canvas of the content design GUI.

In some embodiments, at block 438 of the content publication workflow 430, a search query is received based on the available content sources of the content provider. For example, an input name may be included in the search query to generate one or more selections for incorporation into a design canvas of the platform. In some embodiments, once the search query is received the content publishing application generates and displays a piece of content (e.g., video content, podcasts, GIFs, infographics, webinars, audio clips, expandable ads, and the like) within the content design GUI. In this manner, the content creator profile may develop, update, manage, and/or design the content for incorporation and publication within the platform of the enterprise. In certain embodiments, at block 440 of the content publication workflow 430 the content publication system generates content. In this manner the content (e.g., video, audio, webinar, and the like) may be displayed within the GUI. In some embodiments, the content may be customized (e.g., edited, augmented) via the content creator device 20A prior to publication of content at block 432 of the content publication workflow 430.

With this in mind, FIG. 7 is a schematic embodiment of a GUI (e.g., a content design GUI) generated within the content creation stage 404 of the content publishing application depicted as displayed on a design screen 540. As shown, the GUI as outlined in reference to FIG. 5 may display the design screen 540 during development of content within the design canvas 542. The GUI may allow the content creator profile to select, view, and/or manage one or more content parameter fields 544 deployed by the content creation stage 404 of the content publication system. The content parameter fields 544 may include information provided via the configuration table 408 and access credentials of the available content of the content provider.

The content parameter field 544 may include a title field 546, a provider field 548, and a URL source field 550. The title field 546 may be used to import content provider titles associated with the available content of the content providers. In some embodiments, the title field 546 may be updated by the content creator profile. In this manner, the title field 546 may include searchable terms for subsequent queries by the content creator device 20A and/or the end user device 20B. The provider field 548 may include the one or more content source inputs 512 from the externally hosted content table 504 of FIG. 5. In this manner, the provider field 548 may include sources of externally hosted content. The URL source field 550 may include the API, the content file path, the content provider map, and/or additional pathways to access the available content from the content provider application. It should be noted, that one or more additional fields may be included. For example, the content parameters (e.g., playback parameters, display parameters) as discussed in reference to FIG. 6 may be provided as selection fields within the design screen 540 and/or an additional screen of the GUI. Further, in some embodiments, the content parameter fields 544 may be populated via a video library widget 552 and/or a search widget 554 as described in more detail below in regards to FIG. 8. As such, one or more selected content sources from the available content sources may be embedded on the design canvas 542 of the design screen 540. In some embodiments, the selected content source embedded on the design canvas 542 may include one or more content items associated with a particular piece of the selected content. That is, the content creator may select a portion of the selected content source to include with the design screen 540. In some embodiments, the content item may include a portion (e.g., a specific section of the selected content) from the available content sources of the content provider. In this manner, the content creator device 20A may augment the selected content to publish only a specific portion of the available content sources.

The design screen 540 may allow a video player 556 to be generated and/or embedded within the design canvas 542 to display the selected content source. The video player 556 may include one or more presentation inputs 558 that may be selectable by the content creator to move the video player 556 to a different location within the design canvas 542. That is, the content creator may be able to drag and/or drop the video player 556 to various regions of the design canvas 542 to alter and/or update presentation of the selected content source prior to and/or after publication. In some embodiments, the content creation stage 404 may provide one or more advanced styling inputs 560 (e.g., display parameters). The advanced styling inputs 560 may provide customization and/or augmentation of the selected content source by the content creator profile within the design canvas 542. For example, the advanced styling inputs 560 (e.g., the display parameters) may include a width 562 and a height 564 of the video player 556, and or a margin input 566. The width 562 and the height 564 of the video player 556 may be selected to incorporate into the platform of the enterprise (e.g., newsfeed, timeline, video platform, and the like). The margin input 566 may include a top margin 568, a bottom margin 570, a right margin 572, and/or a left margin 574. In this manner, the video player 556 may be customized for streamlined incorporation into existing content displays of the enterprise.

In some embodiments, the advanced styling inputs 560 may include incorporation of one or more static images and/or one or more text strings within the design canvas 542. In this way, the video player 556 may include static information above, below, and/or within the video player 556 to provide additional information to end user profiles of the enterprise. For example, the text string may include a content item title of the content item to be displayed above the video player 556 to provide context for inclusion of the content item within the platform of the enterprise. In some embodiments, the content item may include a fire safety module and the content item title (e.g., the text string) may identify the module as “Fire Safety Training.”

In some embodiments, the video player 556 may include one or more presentation inputs 558 (e.g., playback parameters). The presentation inputs 558 may include a play bar 576, a volume input 578, a full screen input 580, and/or one or more additional settings 582. As such, presentation of the video player 556 may be augmented during the content creation stage 404 of the content publishing application. For example, the play bar 576 may be disabled. In this manner, the selected content source may be directed to play automatically and/or play in a loop when accessed by the end user device 20B.

In certain embodiments, the design canvas 542, the content parameters fields 544, the advanced styling inputs 560 (e.g., design parameters), and/or additional inputs (e.g., playback parameters) of the content design GUI may be saved via a save input 584 and/or a save and continue input 586. In some alternative embodiments, selection of content, inputs to the content parameters fields 544, the advanced styling inputs, and/or the design canvas 542 may be negated via the cancel input 588. In this way, design of the selected content of the content creation stage 404 may be saved providing content to one or more additional screens such as a publication screen of the content creation stage discussed in detail below in regards to FIG. 9.

In some embodiments, the video library widget 552 and the search widget 554 of the GUI may generate one or more additional screens such as search windows in response to a search input. FIG. 8 is a schematic illustration of a screen 600 displaying a search window 602 of the content publishing application. The search window 602 may include a search bar 604, one or more search results 606, a result count 608, and/or one or more interactive elements. In some embodiments, the interactive elements may include a selection tool 610, a cancel input 612, and/or a save input 614. In this manner, the content creator profile may input a search term 616 into the search bar 604 to search the content sources available for incorporation with the design canvas 542 of the GUI.

As shown, the content creator profile may input “enterprise” as the search term 616. The content publishing application may query the content provider application for the available content related to the search term. It should be noted, in some embodiments, the search window 602 may generate additional information not related to the content provider application such as internal content, publicly hosted content, or a combination thereof. As such, the content publishing application may allow for design and development of internal content, externally hosted content, and publicly available content on the platform. The search window 602 may provide the result count 608 and corresponding results containing the search term 616. In this manner, the content creator profile may use the selection tool 610 to select a content source from the corresponding results. In this manner, the selected content may be saved via the save input 614. In some embodiments, content parameters related to the selected content may be auto populated in the content parameter fields of the GUI on the design screen 540 of FIG. 7.

Referring now to FIG. 9, the content creation stage 404 may include a schematic embodiment of the GUI (e.g., the content design GUI) generated within the content creation stage 404 of the content publishing application depicted as displayed on a publication screen 640. In general, the publication screen 640 of the GUI may allow the content creator profile to preview the selected content, input a location in which to display the selected content, determine an allowed audience of the selected content, or a combination thereof. In this manner, the publication screen 640 may provide a content preview 642 of the selected content, a publication location widget 644, an audience widget 646, or one or more additional widgets (e.g., an access time widget). For example, the access time widget may provide an access time parameter associated with a playback time (e.g., live webinar) of the selected content (e.g., content item) The content preview 642 may provide a screening of the selected content as it may be displayed (e.g., readability, accessibility, buffering speed, and the like) within the platform of the enterprise.

In some embodiments, the publication location widget 644 may include a location in which the selected content may be displayed within the platform of the enterprise. For example, the publication location widget may include a rendering location 648 (e.g., portal, homepage, page of the portal), a playback widget 650, a taxonomy 652 (e.g., category, subcategory), a content topic 654 and the like. In this manner, the publication location widget 644 may be accessed by the content creator device 20A to provide inputs related to content display and presentation within the platform of the enterprise. For example, the rendering location 648 may be set to occur within a webinar page of the platform. In this manner, the end user device 20B may access the content via the webinar page. In some embodiments, the taxonomy 652 and/or the content topic 654 may be used as search terms by the end user device 20B to locate the content within the platform of the enterprise.

In certain embodiments, the audience widget 646 may include an audience parameter 658. In this manner, the content creator profile may select an audience that may access the content (e.g., published content). In this way, access to the content may be provided to all and/or a portion of users of the enterprise. As such, specific audiences may be selected via the audience parameter 658 of the audience widget 646 to control access to the content. For example, a specific video may include training information directed to new hires of the enterprise. In this manner, a new hire audience may be selected within the audience widget 646. As such, the new hire audience may be provided access to the specific video. In an additional non-limiting example, the audience parameter 658 may be selected to correspond to an audience (e.g., a particular end user profile) that has access credentials that correspond with the specific content provided by the content provider. That is, a particular audience of the enterprise may have access to content provider specific content. In this manner, the audience widget 646 may be used to ensure the access credentials of the particular audience match access credential requirements of the content provider application.

In some embodiments, the publication screen 640 may include a save publish plan input 660 and/or a cancel input 662. In this manner, the selected content and associated publication parameters (e.g., audience, location, preview) may be published and/or saved in a database for publication. Additionally and/or alternatively, the save publish plan input 660 may publish the selected content as shown in the content preview 642 of the publication screen 640 of the content publishing application. As such, the selected content may be published and/or rendered to the platform of the enterprise.

With this in mind, referring now back to FIG. 5, the end user device 20B may access the content via an access workflow 442 of the end user stage 406. The access workflow 442 may render content at block 444 enabling the user to view the content of the content publishing application. In some embodiments, the access workflow 442 may at block 446 open a portal page of the platform of the enterprise. In some embodiments, the portal page of the platform may be generated in an end user GUI of the content publishing application. In this manner, the end user GUI may be an end user facing GUI (e.g., employee facing GUI) and may be accessible via the end user device 20B. Further, in some embodiments, the access workflow 442 may proceed to block 448 to generate a content widget on the portal page. In this way, in embodiments in which the end user profile is a member of an allowed audience the content publishing application may render the content at block 444.

FIG. 10 provides a process 680 of generating a content widget of the access workflow 442 of the content publication system. The process 680 may be performed by the end user device 20B, a computing device or controller disclosed above with reference to FIG. 1 or any other suitable computing device(s) or controller(s). Furthermore, the blocks of the process 680 may be performed in the order disclosed herein or in any suitable order. For example, certain blocks of the process may be performed concurrently. In addition, in certain embodiments, at least one of the blocks of the process 680 may be omitted.

At block 682 of the process 680, the content publishing application may receive an access request from a portal page of a GUI (e.g., an end user GUI) of the platform of the enterprise. In some embodiments, the access request may be from an end user profile via an end user device 20B and/or an additional client device (e.g., content creator device 20A). For example, the end user profile may access the portal page of the enterprise including a publication location of the selected content (e.g., content provider hosted content). At block 684 of the process 680, the content publishing application may determine if the end user profile is within an allowed audience (e.g., audience with an access parameter authorized to view content). In certain embodiments, the allowed audience is input into the content publishing application via a content creator profile. In this manner, the content creator profile of the enterprise may control access to published content. In some embodiments, at block 686 of the process 680, the content widget may determine the end user profile is not in the allowed audience and end the process 680.

In certain embodiments, the content publishing application may determine that the end user profile is within the allowed audience and proceed to block 688. At block 688 of the process 680, the content publishing application may determine if a selected content (e.g., content located on the portal page) is external to the enterprise. In some embodiments, externally hosted content may include one or more content sources hosted via an external host (e.g., available content sources, webinars, videos, audio clips, and the like). In some embodiments, the content publishing application may determine that the selected content is not external to the enterprise. In this manner, the process 680 may proceed to block 692 and render the selected content (e.g., internal content).

In certain embodiments, the content publishing application may determine that the selected content is externally hosted and proceed to block 690 of the process 680. At block 690, the content publishing application may receive access credentials to provide authorization to the end user profile to view the selected content. The selected content (e.g., content item) of the portal page may require access credentials (e.g., authorization of the access parameter). For example, the content item may be externally hosted and access credentials may need to be received to verify that the end user profile is permitted to view the content item. In this manner, the content publishing application may reference access credentials via configuration tables of the content provider application and verify access credentials to satisfy one or more conditions of a content provider (e.g., perform access verification in a background of the content widget to provide access credentials).

In some embodiments, the content publishing application may proceed to block 692 and render the selected content. As such, the end user profile may view the selected content within the content widget and/or a video player embedded within the platform of the enterprise. Further, in some embodiments, the end user profile may view the selected content using only access credentials needed to access the portal page. That is the content publishing application may handle access credentials directed to viewing available content sources of the content provider in the background. In this manner, the content publishing application may streamline access of the end user profile (e.g., end user device 20B) within the allowed audience to view the selected content and/or the content item.

Being able to control access of externally hosted content is useful to providing end users with customized materials published on the platform of the content publishing application of the enterprise. Whereas previously end users would access externally hosted content external to the content publishing application of the enterprise and/or access externally hosted content on the content publishing application in a generic form (e.g., not customized to the end user). These techniques result in access controlled, customizable presentation of externally hosted content on the content publishing application of the enterprise. Specifically, as described above, specific audiences may be provided content without need for additional access credentials.

Referring now to FIG. 11, the content publication system may perform a process 700 for generating a content design GUI and an end user GUI. The content design GUI may allow for customizable content rendering parameters, searchability of content, and authorization of viewer credentials of the available content sources of the content provider (e.g., externally hosted). The end user GUI may allow an end user profile to view rendered content. The process 700 may be performed by the end user device 20B, a computing device, or controller disclosed above with reference to FIG. 1 or any other suitable computing device(s) or controller(s). Furthermore, the blocks of the process 700 may be performed in the order disclosed herein or in any suitable order. For example, certain blocks of the process 700 may be performed concurrently. In addition, in certain embodiments, at least one of the blocks of the process 700 may be omitted. Further, it should be noted, that the content publishing application may iteratively perform the blocks outlined in process 700.

At block 702 of the process 700, the content publishing application may generate a content design GUI. The content design GUI may receive a first input selecting a content source (e.g., selected content, selected content source) of one or more available content sources. The available content sources may include one or more content parameters (e.g., rendering parameters). In some embodiments, the available content sources may be hosted via a content provider. As such, one or more configuration tables and/or API maps may provide dynamic incorporation of the selected content sources into a platform of the enterprise. For example, the content publishing application may execute a content provider workflow and output a content provider application that may be accessed in one or more widgets of the content design GUI. As such, the content design GUI may provide access to the content parameters of the selected content sources to provide customization to a content creator profile of the enterprise via the content design GUI.

In some embodiments, the first input may include selection of the content source (e.g., the selected content) from the available content sources of the content provider. The first input may be received via the content creator profile and/or a content creator device. For example, the selected content may include a webinar, a training module, a safety video, an onboarding video, or additional forms of content. In this manner, the content creator profile may search the available content and select the content associated with a portal page of the enterprise.

At block 704 of the process 700, the content publishing application may receive a second input. The second input may include selection of one or more content parameters associated with the selected content source. The second input may include the content parameters as discussed in reference to FIG. 7 as discussed above. Briefly, the content parameters may include content parameters (e.g., display parameters) that may alter a view of the selected content within a design canvas of the content design GUI. For example, the content parameters may include information provided via configuration tables of an associated content provider application of the selected content (e.g., a title, a provider, and a URL, and/or additional content parameters).

At block 706 of the process 700, the content publishing application may receive a third input. The third input may be related to one or more access credentials (e.g., access parameters) of the selected content. The access credentials may be included in the content provider application of the selected content. For example, the access credentials may be based on an authorization status of an allowed audience (e.g., one or more end users of the selected content sources of the content provider). In some embodiments, the access credentials may include a token, a username, a password, and the like. As such, the content creator profile may select the access credentials corresponding to the allowed audience of the selected content to streamline access of the selected content to an end user (e.g., without need for additional access credentials from the end user). In some embodiments, the allowed audience may include all end user profiles of the enterprise and/or a portion of end user profiles of the enterprise.

At block 708 of the process 700, the content publishing application may generate an end user GUI. The end user GUI may be used to render a content item (e.g., the selected content, a portion of the selected content) via a display. The content item may be rendered via the display for end user profiles associated with the allowed audience (e.g., audience with access credentials). At block 710 of the process 700, the content item may be embedded within a video player (e.g., the content widget) of a platform (e.g., the platform of the enterprise, a portal page, an additional platform). In this way, the end user profile (e.g., allowed audience) may be able to view externally hosted content (e.g., the content item) within the platform streamlining processes of the enterprise.

Being able to allow for customizable content rendering parameters, searchability of content, and authorization of viewer credentials of the available content sources of the content provider is useful to improve integration of externally hosted content and provide customizable content for publication on the platform of the content publishing application of the enterprise. Previously, embedding customized content items including externally hosted content within video players of enterprise platforms was cumbersome, prone to failure, and/or non-customizable.

The present disclosure is directed to a content publishing application to enable integration and compatibility of externally hosted content within a platform (e.g., a cloud-based developmental platform) of an enterprise. In this manner, seamless access to content may be offered, providing content for display via client devices, while authentication and/or authorization of viewership may be controlled in a background of the platform. The content publishing application may also provide only a portion of employee profiles (e.g., end user profiles) access to externally hosted content. Further, the content publishing application may allow content (e.g., third-party content) to be configured for integration onto the platform of the enterprise. Additionally, present embodiments include creation of GUIs designed to guide content creation and content viewing within the platform of the enterprise. In this manner, the content publishing application provides streamlined incorporation of content that may include videos, learning materials, and/or specialized dashboards fostering dynamic engagement with the content. Integration of externally hosted content on the platform of the enterprise allows streamlined access of content as part of cloud computing services. Previously, embedding of externally hosted content was cumbersome and/or unsupported. By streamlining externally hosted content integration through incorporation of the content provider stage, the content creation stage, and the content user stage, overall performance in integrating externally hosted on enterprises platforms is improved. The disclosed techniques result in better access to externally hosted content, which improves end user experiences of cloud computing services offered by the enterprise. Technical effects of the disclosed techniques include use of a content publishing application to provide externally hosted content to end users of an enterprise. The content publishing application may include various stages such as a content provider stage, a content creation stage, and/or an end user stage to streamline access of content to end users of the enterprise. The content publishing application may result in reduced computational costs associated with less time spent accessing external content. Further, deployment of the presently disclosed techniques may provide improved efficiency and performance of embedding external content within a platform of the enterprise. Additionally, the content publishing application may be used to control access of externally hosted content to one or more audiences of the enterprise.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
generating a content design graphical user interface (GUI) configured to:
receive a first input selecting a content source of one or more available content sources, each having one or more content parameters;
receive a second input selecting one or more content parameters from the one or more content parameters of the selected content source; and
receive a third input selecting an access parameter, wherein the access parameter defines one or more user profiles authorized to view the selected content source, wherein the one or more user profiles authorized to view the selected content satisfy one or more access credentials including a token, a username, a password, or a combination thereof; and
generating an end user GUI configured to render a content item associated with the selected content source, the one or more selected content parameters, and the selected access parameter via a display of one or more client devices.

2. The method of claim 1, comprising providing access, via one or more application programming interfaces (APIs), to the one or more available content sources.

3. The method of claim 1, wherein the content design GUI is configured to:
display one or more pieces of content based on the selected content source, the selected one or more content parameters, and the selected access parameter; and
receive a fourth input selecting a particular piece of content from the one or more pieces of content;
wherein the content item rendered by the end user GUI comprises the particular piece of content.

4. The method of claim 3, comprising embedding the selected particular piece of content within a video player of a platform.

5. The method of claim 3, comprising augmenting the selected particular piece of content using a design canvas of the content design GUI by incorporating one or more static images, one or more text strings, or both.

6. The method of claim 1, wherein the content design GUI is configured to receive a fifth input selecting an access time parameter, one or more display parameters, one or more playback parameters, or any combination thereof.

7. The method of claim 1, comprising determining whether a particular end user profile is authorized to view a selected particular piece of content based on the selected access parameter.

8. The method of claim 1, wherein the first input, the second input, or the third input, or any combination thereof, is based on one or more configuration tables of a content provider application associated with the available content sources.

9. (canceled)

10. The method of claim 1, wherein the one or more selected content parameters comprise a play bar, a volume, a full screen, or any combination thereof.

11. A system, comprising:
processing circuitry; and
memory, accessible by the processing circuitry, the memory storing instructions that, when executed by the processing circuitry, cause the processing circuitry to perform operations comprising:
generating a content design graphical user interface (GUI) configured to:
receive a first input selecting a content source of one or more available content sources, each having one or more content parameters;
receive a second input selecting one or more content parameters from the one or more content parameters of the selected content source; and
receive a third input selecting an access parameter, wherein the access parameter defines one or more user profiles authorized to view the selected content source, wherein the one or more user profiles authorized to view the selected content satisfy one or more access credentials including a token, a username, a password, or a combination thereof; and
generating an end user GUI configured to:
render a content item associated with the selected content source, the one or more selected content parameters, and the selected access parameter via a display of one or more client devices; and
embed the content item within a video player of a platform.

12. The system of claim 11, wherein the end user GUI is configured to
display one or more pieces of content based on the selected content source, the selected one or more content parameters, and the selected access parameter; and
receive a fourth input selecting a particular piece of content from the one or more pieces of content;
wherein the content item rendered by the end user GUI comprises the particular piece of content.

13. The system of claim 11, wherein the selected access parameter defines whether a particular end user profile is authorized to view a selected particular piece of content.

14. The system of claim 11, wherein the first input, the second input, or the third input, or any combination thereof are based on one or more configuration tables of a content provider application associated with the available content sources.

15. The system of claim 11, wherein the content design GUI is configured to receive a fifth input selecting an access time parameter, one or more display parameters, one or more playback parameters, or any combination thereof.

16. (canceled)

17. A non-transitory computer-readable storage medium, comprising processor-executable routines that, when executed by a processor, cause the processor to perform operations comprising:
generating a content design graphical user interface (GUI) configured to:
receive a first input selecting a content source of one or more available content sources, each having one or more content parameters;
receive a second input selecting one or more content parameters from the one or more content parameters of the selected content source;
receive a third input selecting an access parameter, wherein the access parameter defines one or more user profiles authorized to view the selected content source, wherein the one or more user profiles authorized to view the selected content satisfy one or more access credentials including a token, a username, a password, or a combination thereof;
display one or more pieces of content based on the selected content source, the selected one or more content parameters, and the selected access parameter; and
receive a fourth input selecting a particular piece of content from the one or more pieces of content; and
generating an end user GUI configured to render the particular piece of content associated with the selected content source, the one or more selected content parameters, and the selected access parameter via a display of one or more client devices.

18. The non-transitory computer-readable storage medium of claim 17, wherein the end user GUI is configured to embed the particular piece of content within a video player.

19. The non-transitory computer-readable storage medium of claim 17, wherein the processor performs operations comprising providing access, via one or more application programming interfaces (APIs), to the one or more available content sources.

20. The non-transitory computer-readable storage medium of claim 17, wherein the first input, the second input, or the third input, or any combination thereof, is based on one or more configuration tables of a content provider application associated with the available content sources.

21. The method of claim 1, comprising receiving an access time parameter associated with a playback time of the selected content source.

22. The method of claim 1, comprising determining that the content item associated with the selected content source is externally hosted prior to generating the end user GUI.
